(19) United States
(12) Patent Application Publication
(10) Pub. No.: US 2006/0260600 A1
(43) Pub. Date: Nov. 23, 2006

(54) Grill hole cover

(76) Inventor: Joseph Bieser, Mokena, IL (US)

Correspondence Address: JENKENS & GILCHRIST, P.C., 225 WEST WASHINGTON, SUITE 2600, CHICAGO, IL, 60606, US

(21) Appl. No.: 11/437,548

(22) Filed: May 19, 2006

Related U.S. Application Data
(60) Provisional application No. 60/682,677, filed on May 19, 2005.

(51) Int. Cl. A47J 37/00

(52) U.S. Cl. 126/25 R; 99/450

(57) ABSTRACT

A grill hole cover system. The grill hole cover system includes a grill that has an aperture on a side of the grill. A grill hole cover is removably attached to the grill and adapted for covering the aperture on the side of the grill.

### CROSS-REFERENCE TO RELATEAD APPLICATION

This application claims the benefit of priority of U.S. Provisional Patent Application No. 60/682,677, filed May 19, 2005, which is hereby incorporated by reference in its entirety.

### FIELD OF INVENTION

The present invention relates to grills and more specifically to covers for holes or apertures in grills.

### BACKGROUND OF THE INVENTION

Some of today's standard gas and charcoal-burning grills come complete with holes cut into opposing sides of the top for the installation and use of a rotisserie set. The rotisserie set allows users to use the grill to cook poultry, roasts, ribs or other meats and food on a rotisserie. Because many people enjoy the flavor and moisture of meat cooked on the rotisserie, adding this feature to a grill can be a great benefit.

However, the addition of holes or apertures to the top of the grill provides a way for birds or other small animals to enter into the grill. Small birds such as sparrows have been known to build their nests in the grill after gaining entry through the rotisserie hole. Not only does this create a mess for the owner of the grill, but it is also unsanitary as the birds can carry germs and/or other microscopic organisms into the grill. The owner must clean and sanitize the grill often a time consuming process. Also, if the bird has already laid eggs, the owner may be hesitant to remove the nest. This can also cause stress since the owner will have to wait until the eggs hatch and baby birds fly away before being able to use his or her grill.

Therefore, there is a need for a cover for these holes that still allows the user to use the rotisserie.

### SUMMARY OF THE INVENTION

According to one embodiment of the present invention, a grill hole cover system is provided. The grill hole cover includes a grill having an aperture on a side of the grill. A grill hole cover is removably attached to the grill and adapted for covering the aperture on the side of the grill.

According to another embodiment of the present invention, a method for covering an aperture on a side of a grill is provided. The method includes providing a grill hole cover and removably attaching a grill hole cover to the side of the grill so as to cover the aperture.

According to yet another embodiment of the present invention, a grill hole cover for covering an aperture on a side of a grill is provided. The grill hole cover is movably attached to the grill and is adjacent to the aperture such that the grill hole cover can be moved to allow access to the aperture.

The above summary of the present invention is not intended to represent each embodiment or every aspect of the present invention. The detailed description and Figures will describe many of the embodiments and aspects of the present invention.

### BRIEF DESCRIPTION OF THE DRAWINGS

In the following, the invention will be described with reference to the drawings, wherein:

FIG. 1 is a perspective view of a grill hole cover according to one embodiment of the present invention; and illustrates an embodiment of a hearing aid with a receiver/transducer element therein,

FIG. 2 is a view of the grill hole cover of FIG. 1 attached to a grill.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF THE ILLUSTRATED EMBODIMENTS

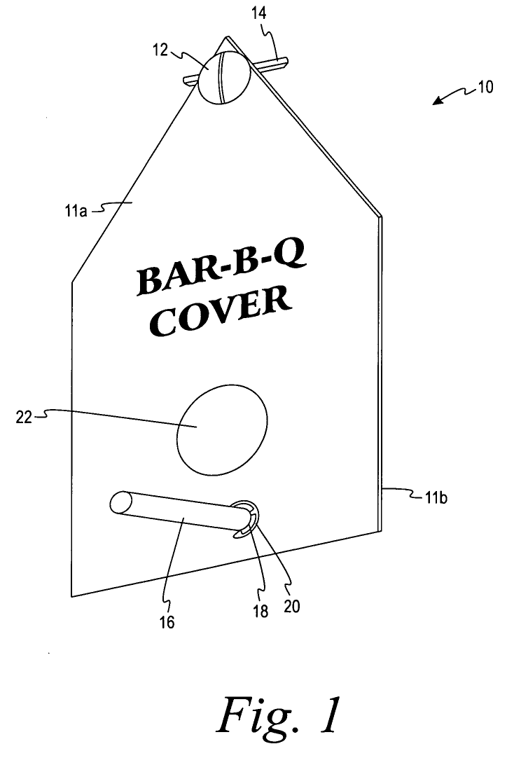

Turning now to FIG. 1, a grill hole cover 10 according to one embodiment of the present invention will be shown. In this embodiment, the grill hole cover 10 has a front side 11a and a back side 11b. The front side 11a includes a screw 12 that passes through the top of the grill hole cover 10. As shown, a wing nut 14 is attached to the screw 10 on the back side 11b of the grill hole cover 10. The bottom of the grill hole cover 10 includes a door pin 16 that passes through a hole 18 in the grill hole cover 10 and extends out of the front side 11a. The door pin 18 is held in place by a clamp 20. In other embodiments, the grill hole cover 10 may include a handle or other protrusion for the user to grasp so as to rotate the grill hole cover.

In the illustrated embodiment, the grill hole cover 10 is in the shape of a house and is between about four inches to about eight inches tall and about two to about four inches wide. The grill hole cover 10 may be stainless steel, metal, plastic or other material. In some embodiments, the material may be a heat resistant material or the material may be painted and/or coated with a heat resistant material so that the grill hole cover 10 does not melt or otherwise deform while a grill is in use.

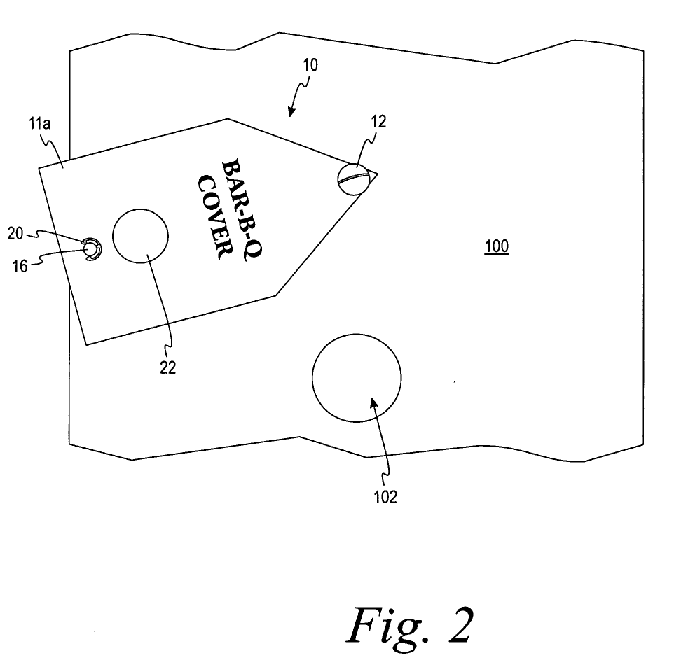

Turning now to FIG. 2, the use of the grill hole cover 10 will be described. As shown, a grill 100 includes a rotisserie hole or other aperture 102. The grill hole cover 10 is attached to a top portion of a grill 100 by the screw 12 and wing nut 14 (FIG. 1) above the aperture 102 (although the grill hole cover 10 may be attached anywhere on the grill 100 adjacent the aperture 102). A hole 104 is drilled in the grill 100 adjacent to the aperture 102. In this embodiment, the drill hole is approximately two to three inches from the aperture. Although any size hole may be drilled, in one embodiment a quarter inch hole is drilled using a quarter inch drill bit. The grill hole cover 10 is then screwed onto the grill 100 using the screw 12. The wing nut 14 is then attached to the other screw 12 on the other side of the grill 100.

In some embodiments, instead of using the screw 12 and wing nut 14 to attach the grill hole cover 10 to the grill 100, the grill hole cover 10 can be spot welded directly to the grill 100 using rivets. Other known methods for fastening materials together may also be used, such as, but not limited to, utilizing a magnetic grill hole cover 10 or using an adhesive.

In this example, the aperture, or hole, 102 is used for adding a rotisserie rack (not shown) to the grill 100, although the grill hole cover 10 may be used to cover any other type of hole such as a venting hole. If the aperture 102 is for a rotisserie rack, the grill hole cover 10 can be rotated into the position shown in FIG. 2, allowing access to the aperture 102. When the aperture is not in use, the grill hole cover 10 can be rotated downward so as to completely cover the aperture 102, thereby keeping birds or other animals from gaining entry.

In the illustrated embodiment, the grill hole cover 10 is shown in the shape of a bird house, with a fake hole 22 painted on for decoration. However, any shape may be used, as long as the grill hole cover is large enough to cover the aperture 102 in the grill 100. In some embodiments, the grill hole cover 10 may be in the shape of commonly grilled foods, such as steak, chicken, hamburgers, potatoes, corn, etc. In other embodiments, the grill hole cover 10 may just be a simple geometric shape, such as a circle or a square. The grill hole cover 10 may include words, such as a name or a saying, or it may be completely blank.

While the present invention has been described with reference to one or more particular embodiments, those skilled in the art will recognize that many changes may be made thereto without departing from the spirit and scope of the present invention. Each of These embodiments and obvious variations thereof is contemplated as falling within the spirit and scope of the claimed invention, which is set forth in the following claims.

What is claimed is:

1. A grill hole cover system comprising:
a grill having an aperture on a side of the grill; and
a grill hole cover removably attached to the grill and adapted for covering the aperture on the side of the grill.

2. The system of claim 1 wherein the grill hole cover, once attached to the grill, is movable relative to the side of the grill.

3. The system of claim 2 wherein the grill hole cover includes a protrusion adapted to be used to move the grill hole cover relative to the side of the grill.

4. The system of claim 3 wherein the protrusion is a post.

5. The system of claim 1 wherein the grill hole cover is adapted to stay attached to the grill during operation of the grill.

6. The system of claim 1 wherein the grill hole cover is made of a heat resistant material.

7. The system of claim 1 wherein the grill hole cover is painted with a heat-resistant material.

8. The system of claim 1 wherein the grill hole cover is coated with a heat-resistant material.

9. The system of claim 1 wherein the grill hole cover is attached to the grill via a screw and a wing nut.

10. The system of claim 1 wherein the aperture is an opening for receiving a rotisserie rack.

11. A method for covering an aperture on a side of a grill, the method comprising:
providing a grill hole cover; and
removably attaching a grill hole cover to the side of the grill so as to cover the aperture.

12. The method of claim 11 further comprising drilling a drill-hole in the side of the grill near the aperture.

13. The method of claim 12 wherein the attaching comprising attaching the grill hole cover via a screw and wing nut through the drill hole.

14. The method of claim 11 wherein the grill hole cover is attached to the side of the grill within about two to about 4 inches of the aperture.

15. The method of claim 11 wherein the grill hole cover provided is in the shape of a bird house.

16. The method of claim 11 wherein the grill hole cover provided is in the shape of food.

17. The method of claim 11 wherein the grill hole cover provided is of a heat resistant material.

18. The method of claim 11 wherein the grill hole cover provided is painted with a heat-resistant material.

19. The method of claim 11 wherein the grill hole cover provided is coated with a heat-resistant material.

20. A grill hole cover for covering an aperture on a side of a grill comprising:
a grill hole cover movably attached to the grill adjacent to the aperture such that the grill hole cover can be moved to allow access to the aperture.
